(19) United States
(12) Patent Application Publication
(10) Pub. No.: US 2019/0345285 A1
(43) Pub. Date: Nov. 14, 2019

(54) QUANTUM DOT POLYMER

(71) Applicant: CHAIN Technology Consultant Inc., Kaohsiung City (TW)

(72) Inventors: Ying-Fu Wang, Kaohsiung City (TW); Peng Du, Zhongshan City (CN)

(21) Appl. No.: 15/973,538

(22) Filed: May 8, 2018

(51) Int. Cl. C08G 18/38; F21V 8/00; G02F 1/1335; C08G 18/76; C08G 18/75; C08G 18/73; C08K 9/06

(52) U.S. Cl. CPC C08G 18/3876; G02B 6/005; G02F 1/133606; C08G 18/7642; G02F 2202/36; C08G 18/73; C08K 9/06; G02F 2001/133614; C08G 18/755

(57) ABSTRACT

A quantum dot polymer, composed of: 0.1 wt. % to 5 wt. % amino-terminated nanosilica particles, 30 wt. % to 50 wt. % isocyanate, 30 wt. % to 50 wt. % mercaptans, 0.1 wt. % to 0.3 wt. % quantum dots, 5 wt. % or less heat stabilizer, 5 wt. % or less light stabilizer, 5 wt. % or less ultraviolet absorber, and 0.1 wt. % to 0.3 wt. % catalyst. The above ingredients are well stirred under a vacuum and low temperature, and a polymer having quantum dots, which has a good adhesion, shorter cure time and higher stability, can then be obtained.

### (a) TECHNICAL FIELD OF THE INVENTION

The present invention relates to a quantum dot polymer, and more particularly to a polymer containing quantum dots having the advantages such as good adhesion, shorter solidification time and higher stability,

### (b) DESCRIPTION OF THE PRIOR ART

Currently, in display development, traditional cathode ray tube (CRT) displays have been replaced by liquid crystal displays (LCD); although the LCD technology have been very much matured recently, they still cannot meet requirements for colors such that there are organic light emitting diode (OLED) and quantum dot (QD) applications to be broadly discussed.

OLED is still very high in production cost, and the technologies thereof would not be break through in a short time. The QD technology is much more mature, the life of QD is longer than the one of OLED, and QT has the advantages of a broader gamut and lower cost compared to OLED. However, many quantum dots must be scattered in polymers based on epoxy resins and thiol compounds and then covered with a barrier film formed by polymer upon application because QD inherently has adverse reactions to water vapor and oxygen. Where epoxy resins and thiol compounds have low adhesion, need a long solidification time, and has a worse stability, which is easy to cause the adverse reactions of the subsequent application of the quantum dots therein. Furthermore, the polymeric thin film is made by coating silicon dioxide on polyethylene terephthalate (PET) film by means of vapor deposition method. But, this method is very high in cost. Furthermore, the quantum dots attached inside the polymer barrier film can be protected, but practically, the edges of the barrier film will be always cut upon application, and the cut positions are easy to be infiltrated by water vapor and oxygen, which affects subsequent application performance seriously.

### SUMMARY OF THE INVENTION

To make QD polymers have the best applicability, reduce the cost and assure not to be infiltrated by water vapor and oxygen upon the QD polymer application, the present invention is proposed.

The object of the present invention is to provide a quantum dot polymer, having good applicability and lower cost.

To achieve the object mentioned above, the present invention proposes a quantum dot polymer, composed of: 0.1 wt. % to 5 wt. % amino-terminated nanosilica particles, 30 wt. % to 50 wt. % isocyanate, 30 wt. % to 50 wt. % mercaptans, 0.1 wt. % to 0.3 wt. % quantum dots, 5 wt. % or less heat stabilizer, 5 wt. % or less light stabilizer, 5 wt. % or less ultraviolet absorber, and 0.1 wt. % to 0.3 wt. % catalyst. The above ingredients are well stirred under a vacuum and low temperature, and a polymer having quantum dots, which has a good adhesion, shorter cure time and higher stability, can then be obtained.

### BRIEF DESCRIPTION OF THE DRAWINGS

FIG. 1 is a cross-sectional view of a quantum dot film of the present invention;

FIG. 2 shows a cross-sectional view of the quantum dot film of the present invention upon implementation;

FIG. 3 is a schematic view of a preferred embodiment of the quantum dot film of the present invention; and

FIG. 4 is a schematic view of another preferred embodiment of the quantum dot film of the present invention

### DETAILED DESCRIPTION OF THE PREFERRED EMBODIMENTS

A quantum dot polymer 1 of the present invention includes: 0.1 wt. % to 5 wt. % amino-terminated nanosilica particles, 30 wt. % to 50 wt. % isocyanate, 30 wt. % to 50 wt. % mercaptans, 0.1 wt. % to 0.3 wt. % quantum dots, 5 wt. % or less heat stabilizer, 5 wt. % or less light stabilizer, 5 wt. % or less ultraviolet absorber, and 0.1 wt. % to 0.3 wt. % catalyst.

In a preferred embodiment, the quantum dot polymer 1 of the present invention can be obtained by fully stirring 5 wt. % amino terminated nanoscale silica particles, 50 wt. % isocyanate, 40 wt. % thiol, 0.2 wt. % quantum dots, 2 wt. % heat stabilizer, 2 wt. % light stabilizer, 0.6 wt. % ultraviolet absorbent, and 0.2 wt. % catalysts under a vacuum and low temperature, where isocyanate is selected from xylylene isocyanate, isophorone diisocyanate or hexamethylene diisocyanate, or a mixture of at least two thereof; Thiol is selected from Pentaeythritol Tetra (3-mercaptopropuonate), 1-Propanethiol, 2,3-bis [2-mercaptoethyl) thio], Glycl Dimercaptoacetate, or Thylolpropane Tri (3-mercaptopropionate), or a mixture of at least two thereof; and the catalyst is selected from organic bismuth or organic tin, or a mixture of the both.

The quantum dot polymer 1 of the present invention is mainly composed of isocyanate and mercaptan, which has better adhesion, faster curing time and higher stability compared to conventional ones mainly composed of epoxy resin and thiol.

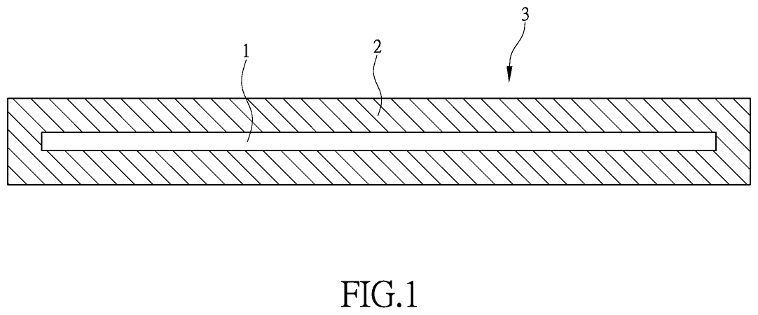

The outer surface of quantum dot polymer 1 of the present invention is configured with a solidification barrier layer 2 to form a quantum dot film 3 for application. Referring to FIG. 1, the solidification barrier layer 2 may include 0.1 wt. % to 10 wt. % acrylic grafted nano-silica particles, 45 wt. % to 60 wt. % modified acrylic resin, 25 wt. % to 40 wt. % reactive diluent, 3 wt. % initiator, 4 wt. % stabilizer and 1 wt. % UV absorber.

In a preferred embodiment, the solidification barrier layer 2 is composed of 5 wt. % acrylic grafted nanosilica particles, 55 wt. % modified acrylic resin, 32 wt. % reactive diluent, 3 wt. % initiator, 4 wt. % stabilizer, and 1 wt. % ultraviolet absorber, where the modified acrylic resin is epoxy acrylate or urethane acrylate, or a mixture thereof; the reactive diluent is trifunctional acrylic acid (for example, TMPTA/TMPTMA), tetrafunctional acrylic acid (DITMP4A) or pentafunctional acrylic acid (DPHA), or a mixture of at least two thereof.

From the description mentioned above, the quantum dot polymer 1 is covered with the solidification barrier layer 2 to form a quantum dot film 3 so as to be available for application, the manufacturing steps of which are the following:

Step 1: spreading the solidification barrier layer 2 on a substrate, where the substrate may be PMMA, PS, PET, MS, PC or glass, and thickness thereof is in the range from 10 to 100 micrometers.

Step 2: spreading the quantum dot polymer 1 on the solidification barrier layer 2, where the spreading thickness thereof is in the range between 10 and 1,000 micrometers;

Step 3: spreading the solidification barrier layer 2 again on the quantum dot polymer 1, where the spreading thickness thereof is in the range between 10 and 100 micrometers; and

Step 4: irradiation the solidification barrier layer 2 with ultraviolet light such as UV LED, high pressure mercury lamp, or metal halide lamp to solidify the solidification barrier layer 2.

As the description mentioned above, the quantum dot polymer 1 being covered and protected by the solidification barrier layer 2 can stop the filtration of water vaper and oxygen effectively, ensuring that the quantum dot polymer 1 can achieve its proper light conversion efficiency. Furthermore, the quantum dot film made in a spreading way according to the present is lower in production cost so as to have an economic effect compared to the similar products made by means of vapor deposition. Furthermore, in implementation, the quantum dot film 3 of the present invention 3 may further includes the substrate 31 for the spreading of the solidification barrier layer 2 upon formation thereof, thereby allowing the rigidity of the quantum dot film 3 to be increased to further facilitate the packing, transportation and related applications thereof.

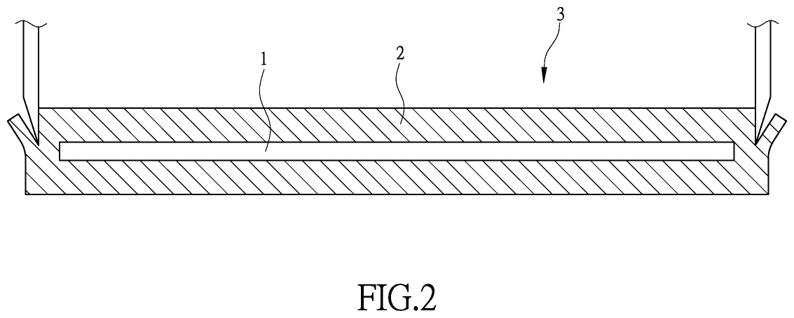

Referring to FIG. 2, the two side edges of the quantum dot film 3, in subsequent applications, may be cut to form a predetermined area for application; when the two side edges of the quantum dot film 3 is being cutting, it can be ensure that the quantum dot polymer 1 inside the quantum dot film 3 is not in contact with air and maintain the barrier to water vapor so that the due effect of the application thereof can be kept because only the solidification barrier layer 2 is trimmed.

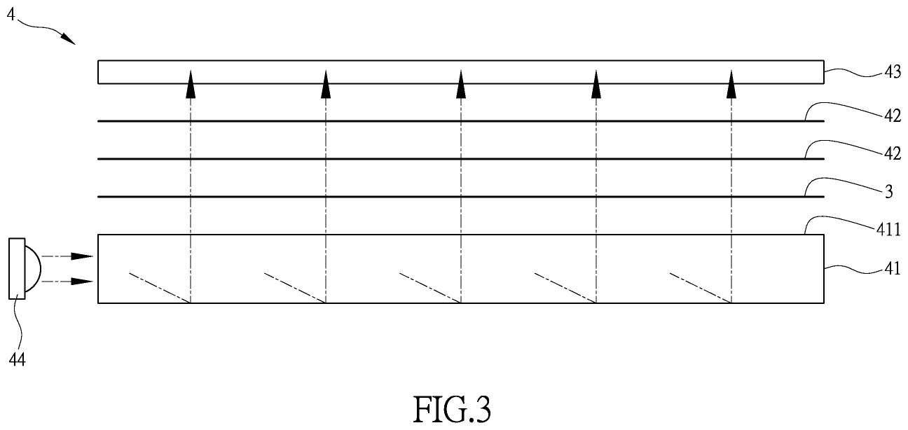

Referring to FIG. 3, the present invention, in a preferred embodiment, can be applied in a side-light type backlight module 4 at least including a light guide plate 41, a several optical films 42, an LCD panel and a light source 44, and the quantum dot film 3 of the present invention is placed on a light exit surface 411 of the light guide plate 41 in the side-light type backlight module 4. Furthermore, the optical films 42 are placed on the quantum dot film 3 of the present invention, and the LCD panel 43 is finally the optical films 42, thereby allowing light emitted from the light source 44 to enter the quantum dot film 3 of the present invention after leaving the light guide plate 41 to make the light have a good light conversion efficiency and increase the application efficiency of light energy. Thereafter, the light is provide for the LCD panel 43.

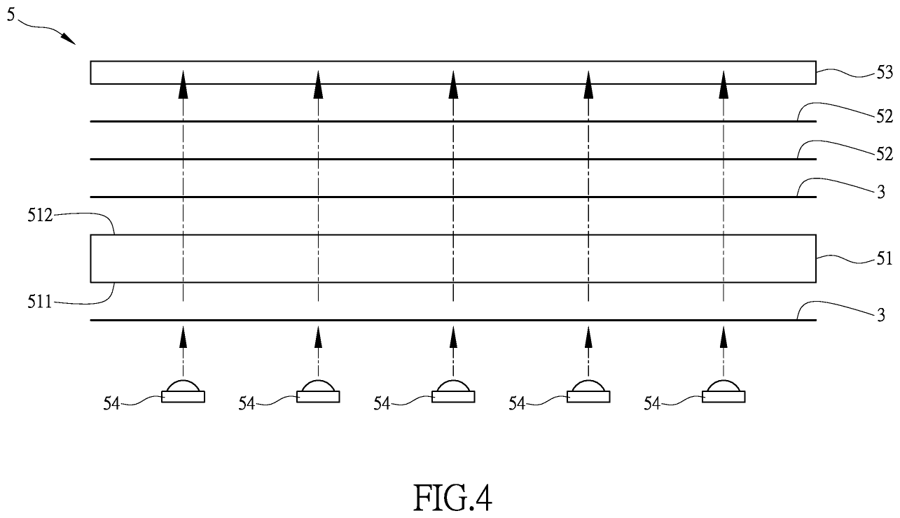

Referring to FIG. 4, the present invention, in another preferred embodiment, may be applied in a direct-type backlight module at least including a diffusion plate 51, a several optical film 52, an LCD panel 53 and a light source. The quantum dot film 3 of the present invention is placed on a light entrance surface 511 or light exit surface 512 of the diffusion plate 51 or respectively placed on the both, allowing the light of the light source 54 to be affected by the quantum dot film 3 of the present invention before entering the diffusion plate 51 or after leaving the diffusion plate 51, or both before entering the diffusion plate 51 and after leaving the diffusion plate 51 so as to improve the light output of the light source.

Conclusively, the quantum dot polymer 1 of the present invention is mainly composed of isocyanate and mercaptan, which has better adhesion, faster curing time and higher stability compared to conventional ones mainly composed of epoxy resin and thiol. Furthermore, the outer surface of the quantum dot polymer 1 of the present invention is configured with the solidification barrier layer 2 to form the quantum dot film 3 having a good water vapor and oxygen barrier properties, allowing it not be damaged by water vapor and oxygen upon application to keep the good conversion of quantum dots to light.

I claim:

1. A quantum dot polymer, composed of: 0.1 wt. % to 5 wt. % amino-terminated nanosilica particles, 30 wt. % to 50 wt. % isocyanate, 30 wt. % to 50 wt. % mercaptans, 0.1 wt. % to 0.3 wt. % quantum dots, 5 wt. % or less heat stabilizer, 5 wt. % or less light stabilizer, 5 wt. % or less ultraviolet absorber, and 0.1 wt. % to 0.3 wt. % catalyst.

2. The polymer according to claim 1, wherein said isocyanate is selected from xylylene isocyanate, isophorone diisocyanate or hexamethylene diisocyanate, or a mixture of at least two thereof;

3. The polymer according to claim 1, wherein said Thiol is selected from Pentaeythritol Tetra (3-mercaptopropuonate), 1-Propanethiol, 2,3-bis [2-mercaptoethyl) thio], Glycl Dimercaptoacetate, or Thylolpropane Tri (3-mercaptopropionate), or a mixture of at least two thereof;

4. The polymer according to claim 1, wherein said catalyst is selected from organic bismuth or organic tin, or a mixture thereof.

5. A quantum dot film, comprising said quantum dot polymer according to claim 1 and a solidification barrier layer outside said quantum dot polymer, said solidification barrier layer composed of 0.1 wt. % to 10 wt. % acrylic grafted nano-silica particles, 45 wt. % to 60 wt. % modified acrylic resin, 25 wt. % to 40 wt. % reactive diluent, 3 wt. % initiator, 4 wt. % stabilizer and 1 wt. % UV absorber.

6. The film according to claim 5, wherein the modified acrylic resin is epoxy acrylate or urethane acrylate, or a mixture thereof.

7. The film according to claim 5, wherein said reactive diluent is trifunctional acrylic acid (for example, TMPTA/TMPTMA), tetrafunctional acrylic acid (DITMP4A) or pentafunctional acrylic acid (DPHA), or a mixture of at least two thereof.

8. The film according to claim 5, wherein said quantum dot film is used to place on a light exit surface of a light guide plate in a side-light type backlight module.

9. The film according to claim 5, wherein said quantum dot film is used to place on a light entrance surface or light exit surface of a diffusion plate or respectively placed on the both in a direct-light type backlight module.

10. The film according to claim 5, wherein a substrate is configured outside said solidification barrier layer of said quantum dot film, said substrate is PMMA, PS, PET, MS, PC or glass.
